(19) United States
(12) Patent Application Publication
(10) Pub. No.: US 2014/0373033 A1
(43) Pub. Date: Dec. 18, 2014

(54) ELECTRONIC DEVICE AND METHOD FOR LAUNCHING AN APPLICATION INSTALLED IN THE SAME THROUGH ADDRESS INFORMATION

(71) Applicant: Insyde Software Corp., Taipei City (TW)

(72) Inventor: I-Te CHEN, Taipei City (TW)

(21) Appl. No.: 14/298,554

(22) Filed: Jun. 6, 2014

(30) Foreign Application Priority Data
Jun. 14, 2013 (TW) 102121075

(51) Int. Cl. G06F 9/54; G06F 3/0482; G06F 9/44

(52) U.S. Cl. CPC G06F 9/541; G06F 9/4443; G06F 3/0482
USPC 719/328

(57) ABSTRACT

A method for launching an application installed in an electronic device through address information is performed by an electronic device and has steps of identifying a piece of address information; launching an application associated with address information; and using the piece of address information to perform a function of the associated application. When address information on the electronic device is clicked, the method can directly launch the associated application to perform functions of the application, such as navigation or route planning. Accordingly, address information displayed on the electronic device can be more flexibly and conveniently utilized.

### BACKGROUND OF THE INVENTION

1. Field of the Invention

The present invention relates to an application-launching method, and more particularly to a method for launching an application installed in an electronic device through address information.

2. Description of the Related Art

Since the commercialization of the Internet, search through websites has become one of the major channels for contemporary people to access different kinds of information. All walks of life, including regular individuals, corporations, businesses, government organizations and the like, flock to resourceful websites and take advantage of the Internet as a critical means for marketing, advertising campaign or promotion activity. Whatever the platforms, such as websites, blogs, or social networks, are, owners of the platforms tend to provide all sorts of information in detail for the purpose of promotion. The provided information includes basic contact information, such as email, address, phone number and the like. After finding a specific platform, regular users can acquire address and contact means of the place associated with the platform through the disclosed information on the platform. Supposing that the platform is a website of a restaurant, consumers use the Internet to identify the website of a famous restaurant, and call the restaurant for reservation and visit the restaurant according to the listing of phone number and address on the web page of the website.

As a result of progress of electronic and communication technologies, latest smart mobile devices, such as smart phones and tablet personal computer (PC), can be also used as the tools for Internet connection and are more advanced functionally than the conventional on-line tools, such as desktop computers or notebook computers, and are tailored to users' demands. For example, when using an electronic mapping application, a desktop computer just needs to search for a destination and input a current location for the electronic mapping application to plan for a desired route. As mid-to-high level smart mobile devices are all built in with GPS (Global Positioning System) modules, as long as an electronic mapping application is performed on a smart mobile device, the GPS module first identifies user's current location, plans for a desired route between the current location and a destination searched by the user, and further provides navigation services.

However, the forgoing route-planning and navigation functions are completed by the running application (electronic mapping application or navigation software), and the destination is also generated by the search result of the application. When a destination address is acquired from a browser upon browsing a web platform instead of being acquired from an application, the browser cannot provide the route-planning and navigation functions conveniently as in the application. The address information on the web platform should be duplicated in the browser and pasted in the application, such as an electronic mapping application or a navigation application, such that the route-planning and navigation functions can then be provided. Such operation is indeed inconvenient and does not satisfy intuitive operation emphasized by all kinds of latest smart mobile devices.

### SUMMARY OF THE INVENTION

An objective of the present invention is to provide a method for launching an application installed in an electronic device through address information. After detecting a piece of address information, the method directly launches an application associated with the piece of address information and uses the piece of address information to perform the application, thereby eliminating the repetitive memorizing or inputting step.

To achieve the foregoing objective, the method performed by an electronic device has steps of:

identifying a piece of address information;

launching an application associated with address information; and

using the piece of address information to perform a function of the associated application.

The foregoing method creates association between the identified address information and a particular application. Hence, when users click on the piece of address information on the electronic device, the associated application can be directly launched to perform a function thereof using the identified address information. For example, when the foregoing method is applied to navigation or route planning function, an electronic mapping application or navigation software associated with address information can directly employ the identified address information as a destination to perform navigation or provide route planning. Thus, the users only need to take a single action to launch a specific function that used to be launched by a series of actions. Accordingly, users' operation can be more easy and convenient.

Another objective of the present invention is to provide an electronic device that directly launches an application associated with address information clicked by users in an application or on a web platform.

To achieve the foregoing objective, the electronic device has an input/output (I/O) interface and a control unit.

The control unit is electrically connected to the I/O interface, identifies a piece of address information according to a click selection detected by and transmitted from the I/O interface, and launches an application associated with the piece of address information.

When users click on the I/O interface, the electronic device determines if a piece of address information is identified, launches an application associated with the identified address information, and performs a function of the application with the identified address information. Accordingly, an electronic device conveniently utilizing address information to perform a particular application can be provided.

Other objectives, advantages and novel features of the invention will become more apparent from the following detailed description when taken in conjunction with the accompanying drawings.

### BRIEF DESCRIPTION OF THE DRAWINGS

FIG. 1A is a functional block diagram of an embodiment of an electronic device in accordance with the present invention;

FIG. 1B is a functional block diagram of another embodiment of an electronic device in accordance with the present invention;

FIG. 2 is a flow diagram of a method in accordance with the present invention;

FIG. 3 is a schematic view showing a page for launching an application through address information contained therein in accordance with the present invention; and

FIG. 4 is a schematic view showing another page for launching an application through address information contained therein in accordance with the present invention.

### DETAILED DESCRIPTION OF THE INVENTION

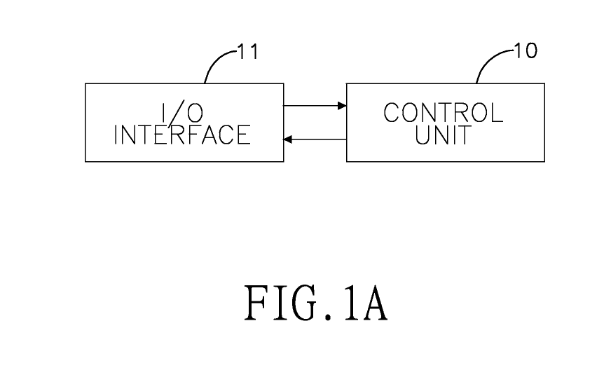

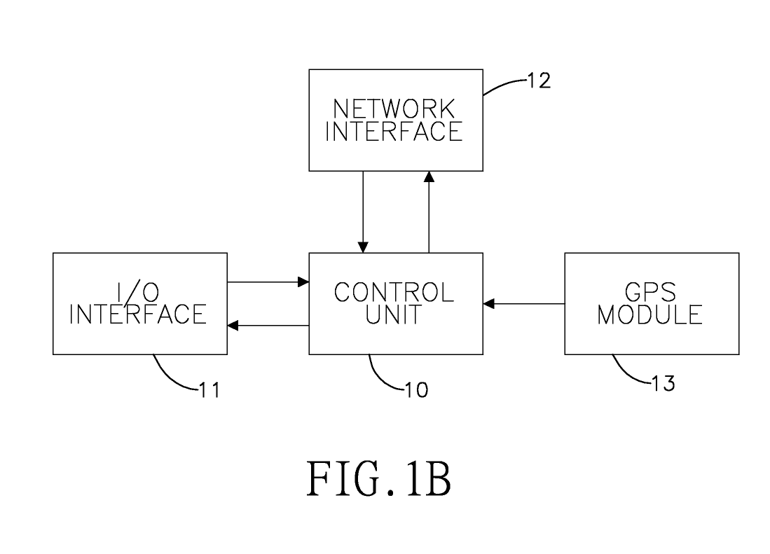

With reference to FIG. 1, an embodiment of an electronic device in accordance with the present invention includes, but is not limited to, desktop computers, notebook computers, smart phones and tablet PCs, and has an input/output (I/O) interface 11 and a control unit 10 electrically connected to the I/O interface 11.

When the electronic device is a desktop computer or a notebook computer, the I/O interface may be a keyboard, a mouse, a touch pad or a display, and the control unit 10 may include a central processing unit (CPU), necessary memories and peripheral devices. When the electronic device is a smart phone or a tablet PC, the I/O interface may be a touch screen based interface including a touch panel and a display.

With reference to FIG. 1B, another embodiment of an electronic device in accordance with the present invention differs from the foregoing embodiment in that the present embodiment further includes a network interface 12. The network interface 12 is electrically connected to the control unit 10. When the electronic device is a desktop computer or a notebook computer, the network interface 12 may be a hardware device, such as a network interface card, in connection with a network. When the electronic device is a smart phone or a tablet PC, the network interface 12 may be a mobile communication module or a wireless network module.

The foregoing electronic device is available to installation and execution of all kinds of applications or is connected to a network through the network interface 12 to browse all kinds of web platforms. In the present embodiment, the electronic device further includes a GPS module 13. The GPS module 13 is electrically connected to the control unit 10 to provide satellite positioning functions.

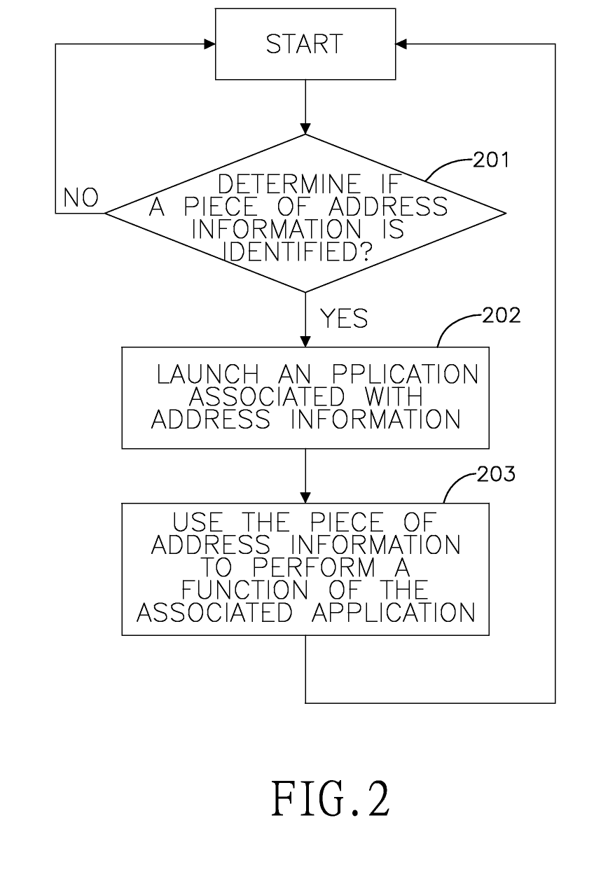

With reference to FIG. 2, a method for launching an application from an electronic device through address information associated with the application in accordance with the present invention is performed by the electronic device and has the following steps.

Step 201: Determine if a piece of address information is identified. If the determination result is negative, resume step 201.

Step 202: Launch an application associated with address information.

Step 203: Use the piece of address information to perform a function of the associated application.

The piece of address information to be identified does not need to have a particular content format. Identification of address information includes, but is not limited to, the following means.

1. Use a network message to identify: The control unit 10 identifies network messages transmitted from the network interface 12. The network messages may take the form of Html label, such as <Address> [address information] </Address>.

2. Use a message of an application to identify: The electronic device is used to trigger execution of a registered event, such as AddressTo:// [address information].

3. Use an electronic mapping application to identify: similar to the recognition using the message of the application.

4. Use a GPS module to identify: when the GPS module identifies a current location of an electronic device, the GPS module automatically identifies the piece of address information of the location.

After users select particular text information in an application or on a web page through the I/O interface 11, the foregoing electronic device determines if the text information is address information with the foregoing identification means. Furthermore, selection of text information includes, but is not limited to, the following patterns.

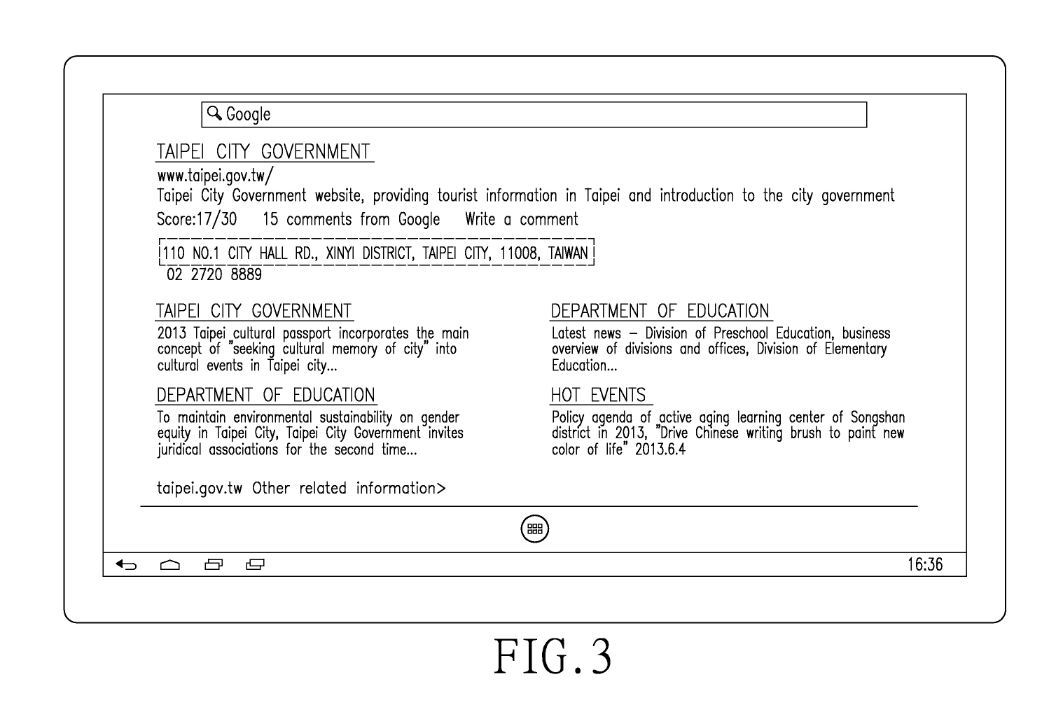

When the electronic device is a desktop computer or a notebook computer, a mouse or a touch pad is used to move a cursor to click on the text information to be selected. After receiving a clicking event sent from the I/O interface 11, the control unit 10 determines if the clicked target is address information. If positive, the control unit 10 then launches an application associated with address information. With reference to FIG. 3, if the electronic device is a smart phone, a tablet PC or a smart mobile device with similar function, the control unit 10 detects a touch or click event on a touch screen based interface of the electronic device and further determines if a touched or clicked location, which is indicated by a dashed line box, is address information. If positive, the control unit 10 then launches an application associated with address information.

As to how to associate an application with a piece of address information, it can be implemented by the following methods.

1. Provide a configuration mode and configure whether an installed application is associated with address information under the configuration mode or not.

2. Upon installation of an application, generate an installation message prompting users for associating the application with address information.

As the foregoing methods associate a specific application with a piece of address information, when detecting the piece of address information, the electronic device immediately executes the application associated with the piece of address information. When the piece of address information is associated with two applications, a menu is generated for users to select one of the applications. Given navigation function as an example, substantially, a method for launching an application according to address information is described as follows.

When a navigation program is installed on the electronic device and configured to be associated with address information and users click a piece of text information on a web page displayed on the electronic device, the control unit 10 detects the click event through the I/O interface 11 and further determines if the clicked text information is address information. If positive, the control unit 10 then launches the navigation program, and the navigation program takes the address information as a destination. In the present embodiment, the electronic device further has a GPS module 13. Hence, upon execution of the navigation program, the GPS module 13 can position a current location of the electronic device beforehand and the current location can be preset as a starting location for navigation execution.

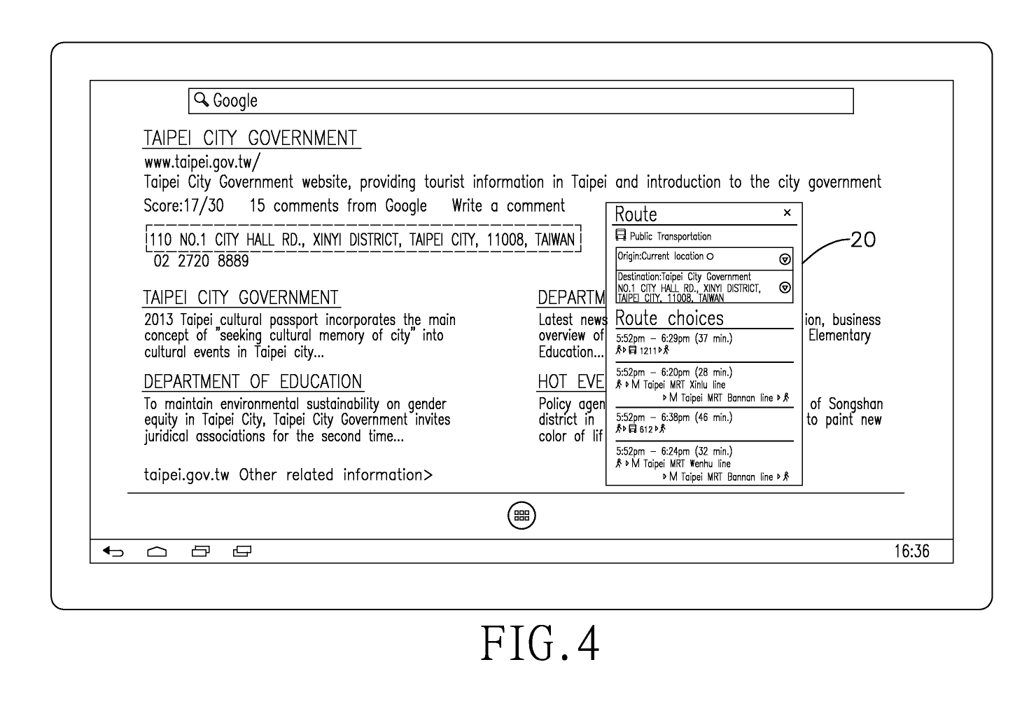

In the foregoing embodiment, the navigation program is launched and continuously performed after address information is identified. Besides the foregoing methods, with reference to FIG. 4, a pull-down menu 20 is simultaneously generated when the address information is clicked. The pull-down menu 20 displays the destination and routes suggested by an electronic mapping application.

Besides navigation or route-planning functions, the present invention can be applied to editing software for address book, yellow book, business cards and the like. When the identifying address information is clicked by users, the electronic device launches the editing software associated with address information and automatically duplicates the identified address information to an address column of the editing software to eliminate the tedious duplicating and pasting work.

Additionally, the present invention can be also applied to translation applications corresponding to various languages. When the electronic device in accordance with the present invention is equipped with the translation application and the method in accordance with the present invention configures the translation application associated with address information, the GPS module of the electronic device identifies a current location of the electronic device and automatically determines a language corresponding to the current location of the electronic device, and the control unit launches one of the translation applications corresponding to the language. For example, when the electronic device is located in the U.S.A, the GPS module identifies a current location of the electronic device and determines that the electronic device is located in the U.S.A. such that the control unit launches one of the translation applications corresponding to English.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for launching an application installed in an electronic device through address information, the method comprising steps of:
identifying a piece of address information;
launching an application associated with address information; and
using the piece of address information to perform a function of the associated application.

2. The method as claimed in claim 1, wherein the application associated with address information is a navigation application;
the step of using the piece of address information to perform the function of the associated application is performed by the navigation application and has steps of:
presetting a current location of the electronic device as a starting location; and
using the piece of address information as a destination to perform navigation.

3. The method as claimed in claim 1, wherein the application associated with address information is an electronic mapping application;
the step of using the piece of address information to perform the function of the associated application is performed by the electronic mapping application and has a step of generating a pull-down menu displaying the piece of address information as a destination and multiple routes suggested by the electronic mapping application.

4. The method as claimed in claim 1, wherein the application associated with address information is a translation application;
the step of using the piece of address information to perform the function of the associated application is performed by the translation application and has steps of:
identifying the piece of address information of a location of the electronic device; and
using the piece of address information to determine a language corresponding to the piece of address information and launching a translation process of the language.

5. The method as claimed in claim 1, further comprising a step of associating the application installed in the electronic device with address information under in a configuration mode.

6. The method as claimed in claim 1, further comprising a step of associating the application installed in the electronic device with address information based upon an installation message.

7. The method as claimed in claim 1, wherein the step of identifying a piece of address information has a step of identifying the piece of address information through a network message.

8. The method as claimed in claim 1, wherein the step of identifying a piece of address information has a step of identifying the piece of address information through a message of an application.

9. The method as claimed in claim 1, wherein the step of identifying a piece of address information has a step of identifying the piece of address information through an electronic mapping application.

10. The method as claimed in claim 1, wherein the step of identifying a piece of address information has a step of identifying the piece of address information through a global positioning system (GPS) module.

11. An electronic device, comprising:
an input/output (I/O) interface; and
a control unit electrically connected to the I/O interface, identifying a piece of address information according to a click selection detected by and transmitted from the I/O interface, and launching an application associated with the piece of address information.

12. The electronic device as claimed in claim 11, further comprising a global positioning system (GPS) module electrically connected to the control module, wherein the associated application is a navigation application presetting a current location of the electronic device positioned by the GPS module as a starting location and using the piece of address information as a destination to perform navigation after the piece of address information is identified.

13. The electronic device as claimed in claim 12, wherein the control unit identifies the piece of address information through the GPS module.

14. The electronic device as claimed in claim 11, wherein the associated application is an electronic mapping application generating a pull-down menu after the piece of address information is identified, and the pull-down menu displays the piece of address information as a destination and multiple routes suggested by the electronic mapping application.

15. The electronic device as claimed in claim 11, further comprising a GPS module electrically connected to the control module, wherein the associated application is a translation application, the piece of address information corresponds to a current location of the electronic device, and the control unit uses the piece of address information to determine a language corresponding to the piece of address information and launch a translation process of the language.

16. The electronic device as claimed in claim 15, wherein the control unit identifies the piece of address information through the GPS module.

17. The electronic device as claimed in claim 11, further comprising a network interface electrically connected to the control unit for the control unit to identify the piece of address information through a piece of text information on a web page transmitted from the network interface.

18. The electronic device as claimed in claim 11, wherein the control unit identifies the piece of address information through a message of the application.

19. The electronic device as claimed in claim 11, wherein the application is associated with the piece of address information in a configuration mode.

20. The electronic device as claimed in claim 11, wherein the application is associated with the piece of address information based upon an installation message.
